(19) United States
(12) Patent Application Publication
(10) Pub. No.: US 2026/0100999 A1
(43) Pub. Date: Apr. 9, 2026

(54) APPAREL-MATCHING AND MOOD-RESPONSIVE COLOR-CHANGING EYEWEAR SYSTEM WITH NATURAL APPEARANCE AND WITHOUT CONTINUOUS POWER USAGE

(71) Applicant: Eight88 Labs Private Limited, Gurgaon (IN)

(72) Inventor: Pulkit Ahuja, Gurgaon (IN)

(21) Appl. No.: 19/349,093

(22) Filed: Oct. 3, 2025

(30) Foreign Application Priority Data
Oct. 3, 2024 (IN) 202411074571

(51) Int. Cl. H04M 1/72412; G06F 3/01; G09G 3/00; G09G 3/16; H04B 5/79; H04M 1/72454

(52) U.S. Cl. CPC H04M 1/72412; G06F 3/011; G09G 3/03; G09G 3/16; H04B 5/79; H04M 1/72454; G06F 2203/011; G09G 2320/0666; G09G 2330/023; G09G 2354/00

(57) ABSTRACT

The present disclosure relates to an appearance-changing eyewear apparatus (100) comprising a spectacle frame (102) having at least one multi-colour electronic paper display (110) disposed on an outward-facing surface. The display (110) is operatively coupled to a control circuit (130) and a wireless communication module (120) that may include a near-field communication (NFC) interface (122) and/or a Bluetooth Low Energy (BLE) transceiver (124). The eyewear apparatus (100) enables a wearer to select and update the appearance of the frame (102), including up to about 4000 colours, patterns, graphics, textures, or textual messages. Selection and control are performed either via a mobile computing device (202), such as a smartphone application, which communicates wirelessly with the eyewear apparatus (100) or directly through NFC tags of garments or data inputs from the user.

### FIELD OF THE EMBODIMENTS

The present disclosure relates to the field of wearable electronic devices, fashion accessories, and tech-enabled eyewear. More particularly, it pertains to eyeglasses or sunglasses with integrated color changing display technology, enabling dynamic changes in appearance of the frame of the eyewear including such as but not limited to the frame's color, pattern or a combination thereof. The disclosure also encompasses associated systems for wirelessly controlling appearance of the frame (e.g. via near-field communication from a smartphone or clothing tag), and methods for coordinating the eyewear's appearance with respect to contextual attributes such as wearer's outfit, mood, environment or activity.

### BACKGROUND OF THE EMBODIMENTS

Spectacles are widely used by a large portion of the global population. Such eyewear may include prescription spectacles for vision correction, anti-glare glasses to reduce eye strain from screens, or sunglasses to protect the eyes from UV rays. Since the first wearable glasses were invented around the year 1284 by an Italian craftsman, eyeglass frames have undergone continuous evolution in design and materials. Modern frames are made of ultra-light yet strong materials, making them highly flexible and durable. In some modern designs, lenses attach directly to minimal frames or only a bridge (so-called “frameless” glasses) to maximize comfort and style.

One important advancement in recent decades has been the introduction of photochromic materials in lenses (and sometimes frames). Such materials automatically change their tint or color when exposed to sunlight. Such a prior art provides a single pair of glasses with dual functionality such as clear indoors and tinted as sunglasses outdoors. However, photochromic lenses or frames typically switch between only two states (for example, clear and one shade of dark), limiting their stylistic versatility. As a result, style-conscious users still often purchase multiple frames in different colors or patterns to match various outfits or occasions. This not only incurs extra cost but also leads to waste, as outdated or seldom-worn frames may end up discarded. Traditional frames are usually made of non-biodegradable plastics or mixed materials, meaning old glasses contribute to landfill waste for many years.

Electrochromic eyewear, on the other hand, represents an electronic approach where the lens tint may be actively adjusted by applying a small voltage. Such systems, explored by start-ups and research groups, allow manual darkening or lightening of the lens. While such eyewear provides more control than photochromic materials, the technology still focuses only on lens transparency, not frame appearance, and it typically consumes continuous power, limiting battery life and practicality.

Attempts at smart eyewear with digital features have also emerged. These devices embed micro-displays, cameras, microphones, or audio components in eyewear. However, their focus is on projecting digital information or capturing media, not on fashion or personalization. Furthermore, they are bulky, costly, and power-hungry, often appearing more like gadgets than everyday accessories.

In the consumer market, LED-based novelty eyewear is also available. Such products, often sold as party glasses, integrate LED strips or patterns that may blink or flash in various colours. While eye-catching, these glasses are impractical for daily wear as they require continuous power, appear gaudy, and fail to provide the natural look expected of eyewear.

Despite these technological developments, the majority of eyewear still provides fixed aesthetics, requiring users to own multiple frames in different colours and designs for fashion purposes. Such a feature increases expense and contributes to environmental waste, since most frames are made of non-biodegradable plastics or mixed composites that persist in landfills for decades. There is a need for a practical, energy efficient, and user-friendly eyewear system that allows eyewear frames to be easily and frequently restyled in terms of colour and pattern. Such a system may facilitate coordination of appearance of the eyewear with the wearer's clothing, mood, or contextual activities, thereby eliminating the necessity of owning multiple physical frames. Such a system may enhance personal fashion flexibility while simultaneously reducing environmental waste, and may further be implemented in a manner that preserves the natural aesthetic of eyewear, avoiding the drawbacks associated with conspicuous electronic displays or solutions requiring continuous power consumption.

### OBJECTIVE OF THE EMBODIMENTS

The principal objective of the present disclosure is to provide an appearance-changing eyewear apparatus incorporating at least one bistable electronic paper display integrated into the spectacle frame, the display being capable of dynamically altering the appearance of the frame (102), including one or more of a colour, a pattern, a graphic, a texture, an image, a symbol, or any combination thereof.

Another objective of the present disclosure is to provide adaptive eyewear frames that allow a single pair of glasses to exhibit multiple visual appearances on demand in a natural, non-emissive appearance, thereby reducing the need for a wearer to maintain several physical frames for different occasions.

Another objective is to provide an eyewear apparatus that operates at ultra-low power consumption by employing bistable electronic paper displays that require energy only during updates.

Another objective of the present disclosure is to provide eyewear frames that may be wirelessly controlled through a communication module incorporating interfaces such as NFC and/or BLE, enabling seamless interaction with external devices including smartphones, wearable tags, or other computing systems.

Another objective of the present disclosure is to provide eyewear frames that are context-responsive, wherein the displayed appearance may be automatically adapted based on contextual attributes such as the wearer's outfit, user's attire, mood, activities, biometric indicators detected by sensors, environmental conditions, event themes, notifications, contextual indicators or combinations thereof.

Another objective of the present disclosure is to achieve the above functions while maintaining a low or zero power profile, wherein the bistable nature of the electronic paper display allows the selected appearance to be retained without continuous power, supported by rechargeable power sources, inductive charging coils, or energy-harvesting mechanisms.

Another objective of the present disclosure is to provide eyewear frames that preserve the natural look and aesthetic of conventional eyewear, by embedding electronic components such as the multi colour electronic paper display, control circuit, and communication module seamlessly within the frame without compromising style, natural matte or glossy finish, form factor, and fashion appeal.

Another objective of the present disclosure is to provide sustainability and reduced environmental waste by enabling a single eyewear apparatus to deliver virtually limitless stylistic variations, thereby reducing the need for discarding outdated or redundant frames.

Another objective of the present disclosure is to provide eyewear frames with enhanced operational life and durability, supported by power-efficient electronics, rechargeable energy sources, water-resistant sealing of electronic components, and robust frame construction.

Another objective of the present disclosure is to provide advanced features, including synchronization of appearance among multiple eyewear apparatuses via BLE peer-to-peer communication, mood-based appearance changes derived from biometric data, and remote updates through cloud-based services, thereby extending utility for social, fashion, and functional applications.

Another object of the present disclosure is to provide a system wherein a mobile application is configured to control the eyewear apparatus by enabling manual design of appearance (through colour wheel, palette, emoji/text inputs, and segmented panel control), outfit suggestion (camera-based clothing analysis and matching), scheduling and automated modes (such as work mode, mood ring mode, and event mode), as well as firmware updates and configuration options.

Another object of the present disclosure is to provide an environmentally sustainable eyewear system that reduces plastic consumption and waste by allowing a single smart frame to digitally present countless styles, thereby eliminating the need to purchase multiple fashion-specific frames.

### SUMMARY OF THE EMBODIMENTS

In one aspect, the present disclosure provides an appearance-changing eyewear apparatus (100). The apparatus (100) comprises a spectacle frame (102) having a bridge (104) and temple arms (106) for supporting lenses (108). At least one multi-colour bistable electronic paper display (110) is disposed on an outward-facing surface of the frame (102). The display (110) is operatively coupled to a control circuit (130) and a wireless communication module (120), which may include a near-field communication (NFC) interface (122) and/or a Bluetooth Low Energy (BLE) transceiver (124). The control circuit (130) is configured to drive the electronic paper display (110) to selectively change the appearance of the frame (102), the appearance being selected from one or more of a colour, a pattern, a graphic, a texture, an image, a symbol, or any combination thereof, in response to an activation means, while retaining the chosen appearance without continuous power.

In another aspect, the present disclosure provides a system (200) for coordinating the appearance of an eyewear apparatus (100) with contextual attributes. The system (200) includes the eyewear apparatus (100) and a mobile computing device (202) having a processor, a camera, and a wireless transceiver. The mobile computing device (202) is configured to acquire contextual data, such as user attire, mood, environmental condition, or event theme, determine a recommended appearance for the eyewear apparatus (100), and transmit a command to the wireless communication module (120) of the eyewear apparatus (100). In response, the control circuit (130) updates the electronic paper display (110) to exhibit the recommended appearance automatically. The present disclosure further provides a system (200) wherein a dedicated mobile application (202) enables manual customization of the eyewear apparatus (100), outfit matching using camera input, scheduling and automated context-based modes, and remote firmware updates, thereby enhancing usability and control. The present disclosure also emphasizes environmental and economic benefits by enabling a single eyewear apparatus (100) to digitally present numerous styles, thus reducing the need for multiple physical frames and minimizing plastic consumption and waste.

In yet another aspect, the present disclosure provides a method (300) of updating the appearance of an eyewear apparatus (100). The method (300) comprises detecting data from an NFC tag or other source associated with a contextual attribute of a user, determining an appearance for the electronic paper display (110) based on the detected data, and activating the display (110) to exhibit the determined appearance. The determined appearance may correspond to, complement, or contrast with the contextual attribute, thereby enabling dynamic coordination of the eyewear apparatus (100) with user attire, mood, environmental conditions, or themes.

In a further aspect, the present disclosure provides an integrated appearance-coordination system. The system comprises the eyewear apparatus (100), a mobile computing device (202), and an external source associated with a contextual attribute of the user. The mobile computing device (202) is programmed to detect the contextual attribute by at least one of reading data from an NFC tag, capturing an image of the user or environment, or receiving contextual data indicative of mood, environmental condition, or event theme. Based on the contextual attribute, the mobile computing device (202) determines an appearance comprising a colour, pattern, graphic, texture, image, symbol, or any combination thereof, and transmits a wireless command to the eyewear apparatus (100). The control circuit (130) then updates the electronic paper display (110) to exhibit the determined appearance.

### BRIEF DESCRIPTION OF THE DRAWINGS OF THE EMBODIMENTS

Other objects, features, and advantages of the embodiment will be apparent from the following description when read with reference to the accompanying drawings. In the drawings, wherein like reference numerals denote corresponding parts throughout the several views:

FIG. 1A illustrates a perspective view of an appearance-changing eyewear apparatus (100) including a spectacle frame (102) with a bridge (104), temple arms (106), and lenses (108), the frame (102) having at least one multi-colour bistable electronic paper display (110) disposed on an outward-facing surface.

FIG. 1B illustrates a block diagram of the eyewear apparatus (100), showing the electronic paper display (110), wireless communication module (120) including an NFC interface (122) and BLE transceiver (124), a control circuit (130), a power source (140), and an optional biometric sensor (150).

FIG. 1C illustrates an embodiment of the eyewear apparatus (100) wherein the electronic paper display (110) is divided into multiple segmented regions (112) on different frame portions.

FIG. 1D illustrates an advanced embodiment of the eyewear apparatus (100) including biometric sensors (150) positioned on inner contact surfaces, and optional transparent solar strips (142) integrated into the temple arms (106) for energy harvesting.

FIG. 2A illustrates a system (200) comprising the eyewear apparatus (100) in communication with a mobile computing device (202), such as a smartphone, for transmitting commands to change the appearance.

FIG. 2B illustrates a dedicated charging case (148) configured to house and recharge the eyewear apparatus (100).

FIG. 2C illustrates an integrated appearance-coordination system including the eyewear apparatus (100), the mobile computing device (202), and an external contextual data source (204, 206), such as a cloud service or IoT network, for delivering environmental, event, or mood-related data.

FIG. 3 illustrates a method (300) of updating the appearance of the eyewear apparatus (100) based on contextual data, including user attire, mood, environment, or event theme.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

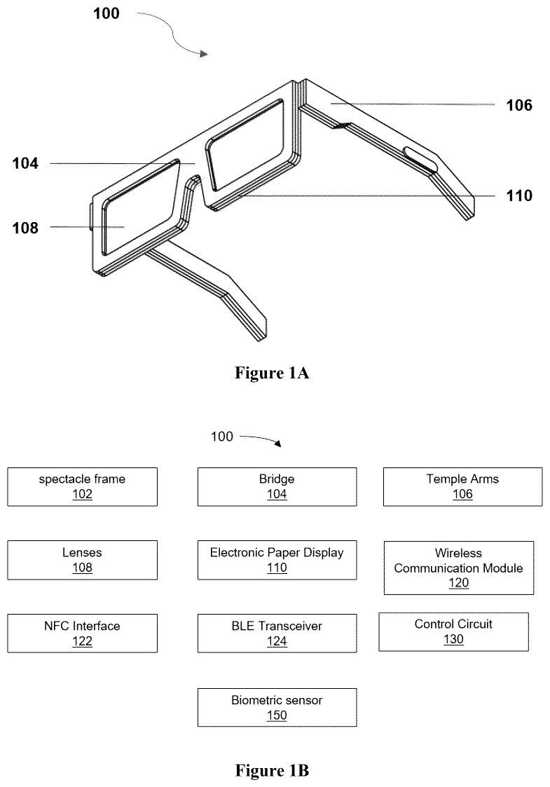

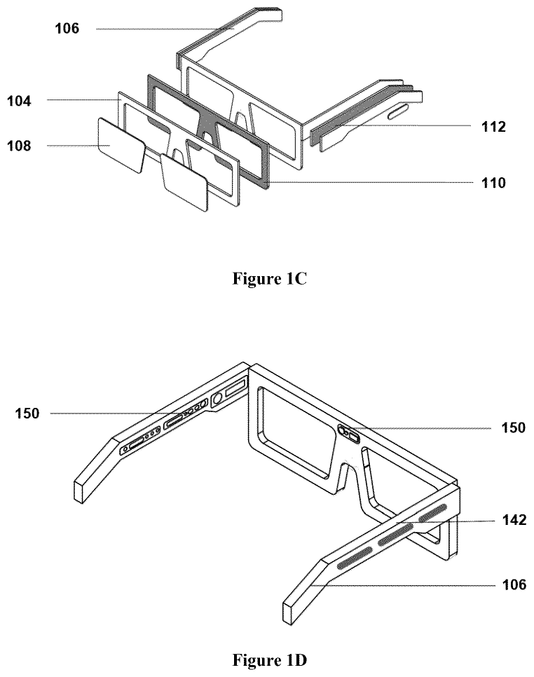

The present disclosure provides an appearance-changing eyewear apparatus (100) (FIG. 1A) (for eyeglasses or sunglasses) that may dynamically alter the appearance of its frames based on the various contextual attributes including such as but not limited to user attire, user mood, environmental condition, or event theme. The appearance may include such as but not limited to a colour, pattern, graphic, texture, image, symbol, or any combination thereof.

As illustrated in FIG. 1A, the appearance-changing eyewear apparatus (100) includes a spectacle frame (102) having a bridge (the part over the nose, which holds the lenses) (104) and temple arms (the pieces that extend over the ears, hinged to the bridge) (106) supporting lenses (108). The bridge (104) and the temple arms (106) are formed from two hollow halves. Sandwiched between these halves is a thin, flexible electronic paper display layer (110) that covers the outward-facing surfaces. Such an embodiment may be implemented, for example, as a segmented e-ink film shaped to fit the frame's contours. A transparent protective outer layer of acetate or polycarbonate may cover the e-ink for durability, while allowing the colours/patterns to show through clearly. The display (110) is configured to selectively alter the appearance of the frame (102). The display (110) is configured to present various colours, patterns, texture, graphics, symbols or images or combinations thereof on the outer surface of the frame. The bistable nature of the display (110) permits the selected appearance to be maintained without continuous power consumption, thereby ensuring low-energy operation while preserving the natural aesthetic of conventional eyewear.

Inside a cavity within one of the temple arms (106) (or distributed across both temple arms (106) and bridge (102) as space allows) lie the compact electronic components that drive the apparatus (100), including such as but not limited to the microcontroller (MCU), the NFC module, the battery or energy storage, and any necessary wiring and display driver chips for the e-paper segments. All circuitry is designed to be unobtrusive and lightweight, maintaining comfort and style. For example, wires connecting power and data to different parts of the e-ink display may be concealed along the inside of the frame or in the hinge area, and the battery may be similar in size to those used in earbuds or small wearables.

A key aspect of the present disclosure is its ultra-low power operation and natural, non-emissive appearance. The electronic paper displays (110) integrated into the frame (102) are bistable, requiring electrical power only during transitions when changing a displayed image or colour, and no power to maintain a selected state. Once the frame's colour or pattern is updated, the appearance remains visible indefinitely without continuous power or backlighting, such that the frame resembles a conventional coloured material rather than an illuminated screen, thereby avoiding glare or visual discomfort to the wearer. The eyewear apparatus (100) is thus capable of operating on a very small battery, since energy is consumed only briefly during updates. Wireless communication technology, particularly near-field communication (NFC), is employed to transmit colour or pattern update data to the frame. The system further leverages the close-range NFC interaction with a smartphone or another NFC-enabled device or tag to transfer data and, in some embodiments, to harvest energy for driving the update, thereby minimizing reliance on the eyewear's internal power source and further reducing energy usage.

As further depicted in FIG. 1B, the eyewear apparatus (100) includes a plurality of electronic components compactly housed within cavities of the spectacle frame (102). A wireless communication module (120) is integrated into the frame (102) to facilitate data exchange with external devices. In one embodiment, the wireless communication module (120) includes a near-field communication (NFC) interface (122) that permits short-range communication with a smartphone, wearable tag, or accessory. The NFC interface (122) may also operate in a passive mode to harvest power from an external NFC field, thereby enabling colour or pattern updates without reliance on the apparatus's internal power source (140). In other embodiments, the wireless communication module (120) further includes a Bluetooth Low Energy (BLE) transceiver (124), enabling bidirectional wireless communication over a longer range, synchronization of appearance with multiple eyewear devices, or reception of contextual data such as location, event information, or environmental cues.

A control circuit (130), such as a low-power microcontroller, is operatively coupled to the wireless communication module (120) and to the electronic paper display (110). The control circuit (130) is configured to receive data representing a selected appearance and to drive the electronic paper display (110) to exhibit the selected appearance in response. The control circuit (130) may further execute algorithms for interpreting contextual attributes, such as attire information, biometric data, or environmental parameters, to automatically determine an appropriate frame appearance.

The electronic components are powered by a power source (140) disposed within the frame (102). In one embodiment, the power source (140) is a rechargeable battery that may be replenished through inductive charging coils, a wireless power receiver, or conductive charging contacts. In certain implementations, harvested energy from NFC fields or supplementary photovoltaic elements may reduce reliance on the battery, thereby extending operational life.

In some embodiments, at least one biometric sensor (150) is integrated into portions of the frame (102) that contact the user's skin. The biometric sensor (150) may include, for example, a heart-rate sensor configured to detect pulse signals, a temperature sensor configured to measure body or skin temperature, or a galvanic skin response sensor configured to detect stress or excitement levels. The biometric sensor (150) provides data to the control circuit (130), which adjusts the electronic paper display (110) dynamically in response to the user's physiological state, thereby implementing a mood-responsive feature that alters the frame's colour, pattern, or other visual attributes in real time.

In the most power-conserving configuration, these core components are minimized so that the eyewear apparatus (100) includes only what is required to receive a colour or pattern update—functioning, for example, as an NFC receiver or tag that a smartphone may write to—and to refresh the electronic paper display (110). This base embodiment emphasizes extremely low power consumption and does not require any active radio or sensor during idle operation, instead relying on the smartphone or external device for computational tasks and user interaction. In certain cases, energy from the NFC field generated by the smartphone may be harvested to drive the display update, thereby enabling the apparatus (100) to operate with little or no reliance on an onboard battery. In some implementations, this configuration permits operation without a battery altogether, or with a very small battery capable of lasting for several months on a single charge. In this basic mode, the user manually initiates colour or pattern changes through a companion smartphone application—for example, by capturing an image of their outfit and tapping the smartphone against the eyewear apparatus (100) to transfer the selected style. When not updating, the eyewear apparatus (100) remains in a quiescent state consuming virtually no power, while indefinitely maintaining the last displayed appearance.

In more advanced embodiments, the eyewear apparatus (100) may include additional modules and sensors that extend its functionality, thereby providing a smart variant of the eyewear. For example, the frame (102) may incorporate biometric sensors such as a heart-rate sensor or a skin-temperature sensor positioned at portions of the frame that contact the wearer, including the inner surfaces of the temple arms (106) or the nose bridge (104). These sensors generate physiological data that may be analysed by the control circuit (130) to implement mood-responsive changes of the electronic paper display (110). In one example, the eyewear apparatus (100) may transition to a calming colour when an elevated heart rate suggests stress, or present a vibrant, animated pattern when increased activity indicates excitement.

The eyewear apparatus (100) may further include a Bluetooth Low Energy (BLE) transceiver (124) in addition to the NFC interface (122). The BLE transceiver (124) enables continuous or on-demand communication with a mobile computing device (202) or with other eyewear apparatuses (100). This supports interactive applications such as synchronizing multiple devices to present a common colour or pattern. For instance, a group of users at a sports event may coordinate their frames to simultaneously display team colours during a celebration. Similarly, at a concert or festival, the eyewear apparatuses (100) may pulse in unison to match the beat of the music.

The BLE connectivity also enables the eyewear apparatus (100) to adapt its appearance automatically based on contextual cues provided by the mobile computing device (202). For example, when the device detects the wearer's arrival at an office location, the eyewear apparatus (100) may switch to a professional monochrome or muted pattern. Conversely, when the user enters a gym, the apparatus may change to a high-visibility colour scheme suitable for athletic activity. In other scenarios, the eyewear apparatus (100) may adopt festive patterns when attending a party or event, or shift to a subdued palette during evening hours, based on scheduled time triggers.

Another enhanced feature of the advanced embodiment is automatic outfit matching via smart tags. In this mode, articles of clothing or accessories worn by the user may be embedded with inexpensive passive NFC tags, for example within garment labels, sewn-in patches, or decorative accessories. Each NFC tag may store data representing a characteristic of the associated article, such as a colour code, a pattern identifier, or a garment ID. When the eyewear apparatus (100) is brought into proximity with a tagged item, for instance, when the user places the glasses near a shirt collar, jacket label, or hat, the NFC transceiver (122) of the eyewear apparatus, operating in reader mode, detects and reads the stored data. The control circuit (130) interprets this clothing data and automatically updates the electronic paper display (110) to a colour, pattern, or combination that coordinates with the outfit, without requiring intervention from the smartphone (202) or other external device.

This feature provides a seamless and intuitive experience: as the user changes clothing, the eyewear apparatus (100) may instantly adjust its appearance to match or complement the outfit simply by detecting the associated garment tag. For example, if the user selects a blue shirt with a tag storing a predefined RGB value, the frame may adopt the exact blue tone; if a patterned dress includes a tag storing a pattern ID, the control circuit (130) may render a corresponding pattern or a complementary solid colour. In another example, when multiple garments are detected, such as a shirt and hat both carrying tags, the eyewear apparatus (100) may apply a prioritization or combination rule to harmonize its display with the overall ensemble.

In a nutshell, the present disclosure encompasses both a minimal, phone-driven embodiment—where the smartphone serves as the primary controller—and a feature-rich smart embodiment that integrates sensors, a BLE transceiver, and an active NFC reader. Both configurations share the same inventive concept of an adaptive colour-changing e-ink eyewear apparatus (100) that operates at ultra-low power by consuming energy only during brief update intervals. The distinction lies in the inclusion of optional modules that enable automatic and interactive functionality, including outfit synchronization, mood-responsive display changes, group coordination, and context-or location-based updates. By describing and claiming these variations within a single application, the disclosure emphasizes the broad inventive step of a scalable, low-power adaptive eyewear system.

The user may select a desired frame appearance through a companion smartphone application, choosing from a broad palette of colours, preset patterns, or custom inputs such as text and graphics, to complement an outfit or express a mood. With a simple action such as tapping the smartphone to the eyewear apparatus (100) or transmitting a wireless command, the selected appearance is applied to the electronic paper display (110), thereby restyling the frame (102) on demand. This functionality enables a single pair of eyewear to present countless different looks, ensuring that the user is not limited to one style and does not require multiple physical frames for fashion purposes. Accordingly, a single pair of smart glasses may be adapted to blend naturally with any outfit or occasion, reducing clutter, minimizing waste, and expanding the user's personal style options.

In one embodiment, corresponding to a base ultra-low-power mode, the eyewear apparatus (100) operates primarily as an NFC target device awaiting input from an external controller, such as the user's smartphone (202). The control circuit (130) remains in a low-power or sleep state, consuming negligible energy until an incoming NFC field or command is detected. To initiate a change of frame appearance, the user interacts with a companion smartphone application that provides a user-friendly interface for either manually selecting a colour or pattern or automatically generating a suggestion. For example, the user may take a selfie or outfit photograph within the application, which then analyzes the clothing and recommends a matching or complementary frame colour scheme. The user may confirm or adjust this recommendation through the application interface.

In a typical update sequence, once the eyewear apparatus (100) detects the NFC field, the control circuit (130) wakes from its sleep state and receives the transmitted data via the NFC interface (122). The control circuit (130) then processes the received code and drives the electronic paper display (110) to render the new appearance. The transition is rapid, typically completing within one to two seconds depending on the complexity of the display update. During this process, the smartphone (202) may provide feedback to the user, such as a vibration or an on-screen confirmation that the frame has successfully updated. Immediately after the update, the control circuit (130) returns to its low-power standby mode. The bistable electronic paper display (110) then maintains the newly set appearance indefinitely without consuming power, ensuring that the frame continues to present the desired colour or pattern until another update is initiated.

To transmit the selected appearance to the eyewear apparatus (100), the smartphone (202) is brought into close proximity to, or tapped against, a designated region of the spectacle frame (102)—typically near the temple hinge where the NFC interface (122) and antenna are embedded, as illustrated in FIG. 1B. Acting as the NFC initiator, the smartphone (202) transmits a compact data packet containing the chosen colour or pattern code. The packet may be formatted using a standard protocol such as NDEF (NFC Data Exchange Format) or a custom lightweight protocol optimized for the eyewear apparatus (100). The payload size is kept minimal: for example, a solid colour may be represented by only a few bytes (e.g., an RGB value or a palette index stored on the control circuit (130)), while a graphic pattern may be transmitted as a compressed image suitable for rendering on the multi-colour bistable electronic paper display (110). When the smartphone (202) generates an NFC field, the eyewear apparatus (100) detects it via the NFC interface (122), causing the wireless communication module (120) to power up and the control circuit (130) (e.g., microcontroller) to wake from its low-power sleep mode, as shown in FIG. 1B. The NFC interface (122) receives the transmitted appearance data and forwards it to the control circuit (130). The control circuit (130) then drives the multi-colour bistable electronic paper display (110), including segmented display regions (112) where provided, to render the newly selected appearance on the frame (102). The update process is typically completed within one to two seconds. Immediately after the update, the control circuit (130) returns the system to a quiescent low-power state. The electronic paper display (110) continues to exhibit the selected colour, pattern, or graphic indefinitely without requiring further power. Because NFC communication operates only at very short range (a few centimetres), this update process is inherently secure and deliberate, minimizing unintended activations. The smartphone (202) may provide haptic or audio confirmation such as a vibration or a chime—once the transfer and update succeed (for example, “Your glasses are now navy blue”).

The use of the multi-colour bistable electronic paper display (110) ensures that the eyewear apparatus (100) draws virtually no power between updates. Unlike conventional emissive display technologies such as LED or LCD, the electronic paper display (110) is reflective and bistable: once a pixel is set to a particular colour, pattern, or graphic, it remains in that state indefinitely without requiring any sustaining electrical current. This property makes the technology ideal for eyewear, since a wearer typically changes the frame's appearance only a few times per day for example, when coordinating with a new outfit in the morning or switching to a special theme in the evening.

During an update cycle, energy consumption is limited to a brief interval in which the control circuit (130), NFC interface (122), and display drivers are powered to refresh the display (110), as depicted in FIG. 1B. A compact rechargeable power source (140), for example a battery of approximately 30-40 mAh capacity, is sufficient to drive many dozens of such updates because the electronics are engineered for ultra-low-power operation. Furthermore, the NFC field generated by the smartphone (202) or external NFC emitter may induce current in the NFC interface (122), enabling the eyewear apparatus (100) to harvest supplemental energy during data transfer. In some implementations, this harvested energy may be adequate to perform a full display update without drawing from the onboard power source (140), thereby allowing the eyewear to function with effectively zero net battery consumption during updates.

Once the electronic paper display (110) is refreshed, the frame (102) requires no additional power to maintain the chosen appearance. Accordingly, in the base configuration, the eyewear apparatus (100) may operate for extended durations from potentially several months to a year on a single battery charge, depending on usage frequency, since the power source (140) is only engaged intermittently during short wake-up periods.

During an update cycle, energy consumption is limited to a brief interval in which the control circuit (130), NFC interface (122), and display drivers are powered to refresh the display (110), as depicted in FIG. 1B. A compact rechargeable power source (140), for example a battery of approximately 30 to 40 mAh capacity, is sufficient to drive many dozens of such updates because the electronics are engineered for ultra-low-power operation. Furthermore, the NFC field generated by the smartphone (202) or external NFC emitter may induce current in the NFC interface (122), enabling the eyewear apparatus (100) to harvest supplemental energy during data transfer. In some implementations, this harvested energy may be adequate to perform a full display update without drawing from the onboard power source (140), thereby allowing the eyewear to function with effectively zero net battery consumption during updates.

Once the electronic paper display (110) is refreshed, the frame (102) requires no additional power to maintain the chosen appearance. Accordingly, in the base configuration, the eyewear apparatus (100) may operate for extended durations from potentially several months to a year on a single battery charge, depending on usage frequency, since the power source (140) is only engaged intermittently during short wake-up periods.

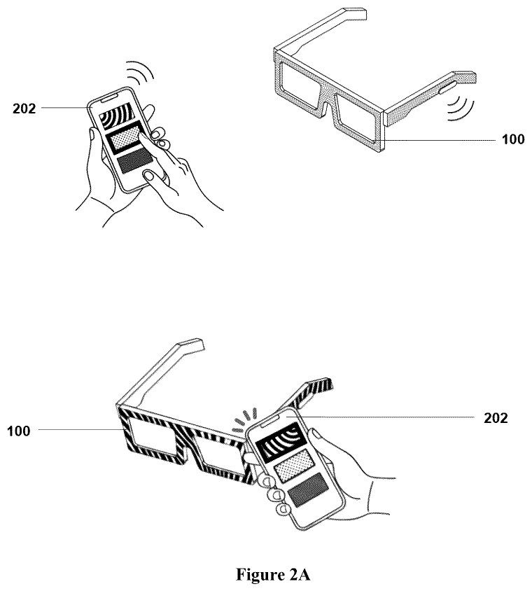

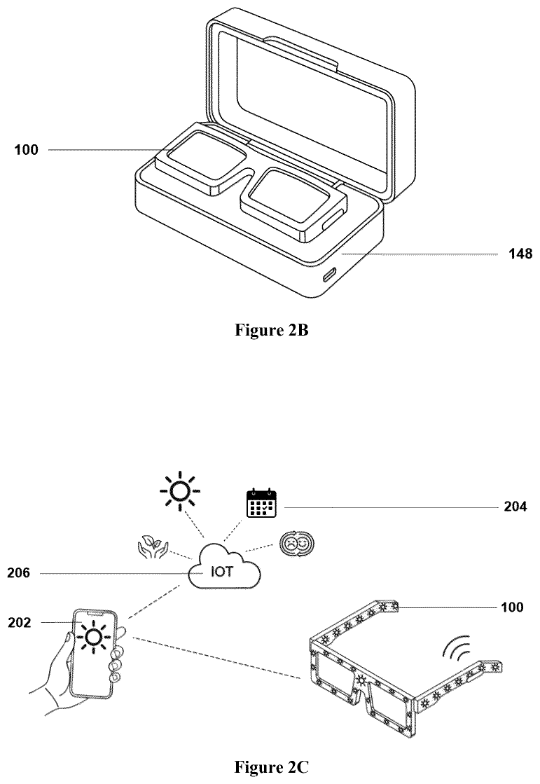

In advanced embodiments, the power source (140) may be recharged wirelessly via an inductive charging coil integrated into the frame (102), as illustrated in FIG. 1B, or through electrical contacts in a dedicated charging case (148), as shown in FIG. 2B. Additionally, transparent solar cells may be embedded along the top edge of the temple arms (106) or bridge (104), providing trickle-charging capability under ambient light conditions. These supplemental charging features further extend battery life and, in certain implementations, enable semi-permanent operation of the eyewear apparatus (100) without requiring frequent manual charging.

During an update cycle, energy consumption is limited to a brief interval in which the control circuit (130), NFC interface (122), and display drivers are powered to refresh the display (110), as depicted in FIG. 1B. A compact rechargeable power source (140), for example a battery of approximately 30 to 40 mAh capacity, is sufficient to drive many dozens of such updates because the electronics are engineered for ultra-low-power operation. Furthermore, the NFC field generated by the smartphone (202) or external NFC emitter may induce current in the NFC interface (122), enabling the eyewear apparatus (100) to harvest supplemental energy during data transfer. In some implementations, this harvested energy may be adequate to perform a full display update without drawing from the onboard power source (140), thereby allowing the eyewear to function with effectively zero net battery consumption during updates.

Once the electronic paper display (110) is refreshed, the frame (102) requires no additional power to maintain the chosen appearance. Accordingly, in the base configuration, the eyewear apparatus (100) may operate for extended durations, potentially several months to a year on a single battery charge, depending on usage frequency, since the power source (140) is only engaged intermittently during short wake-up periods.

In advanced embodiments, the power source (140) may be recharged wirelessly via an inductive charging coil integrated into the frame (102), as illustrated in FIG. 1B, or through electrical contacts or inductive coupling provided in a dedicated charging case (148), as shown in FIG. 2B. The charging case (148) may contain a secondary battery that automatically transfers energy to the eyewear apparatus (100) when it is stowed, thereby ensuring that the device remains consistently charged without requiring direct wired connections. Additionally, transparent solar cells may be embedded along the top edge of the temple arms (106) or bridge (104), providing trickle-charging capability under ambient light conditions. These supplemental charging features further extend battery life and, in certain implementations, enable semi-permanent operation of the eyewear apparatus (100) without requiring frequent manual charging.

In another embodiment, the eyewear apparatus (100) is equipped with one or more biometric sensors (150) integrated into portions of the frame (102) that make direct contact with the wearer. For example, a miniature optical heart-rate sensor, similar to those used in wearable fitness devices, may be positioned on an inner surface of a temple arm (106) such that it contacts the skin above the ear or along the side of the head. Additionally, a skin-temperature sensor or a galvanic skin response (GSR) sensor may be embedded at points of contact such as the nose bridge (104) or temple regions.

The biometric sensors (150) are configured to detect physiological parameters of the wearer, including but not limited to heart rate, body temperature, stress indicators, or activity level. The control circuit (130), implemented as a low-power microcontroller, periodically acquires data from the biometric sensors (150). To conserve energy, sampling may be performed at low frequency, triggered by specific events, or executed on demand. The acquired biometric data is analysed by the control circuit (130) to derive indicators of the wearer's physiological or emotional state, thereby enabling automatic, context-aware adjustments of the appearance shown on the electronic paper display (110).

For instance, if an elevated heart rate and increased skin temperature indicate stress or excitement, the control circuit (130) may drive the electronic paper display (110) to transition into a calming colour such as blue or green, or into a steady, soothing pattern. Conversely, if biometric inputs suggest high energy or positive excitement, the control circuit (130) may trigger the eyewear apparatus (100) to display a more vibrant appearance, such as a dynamic pattern, a bright hue, or an animated symbol. In this manner, the eyewear apparatus (100) provides a mood-responsive visual feedback feature, allowing the appearance of the frame (102) to correspond to, complement, or contrast with the physiological state of the wearer.

Using the biometric data acquired by the sensors (150), the control circuit (130) may implement a mood-responsive mode in which the electronic paper display (110) on the frame (102) automatically changes appearance to mirror or augment the wearer's emotional state. Such adjustments may occur according to predefined logic embedded in the control circuit (130) or according to user-customized settings selectable via the mobile computing device (202).

For example, the eyewear apparatus (100) may display a calm blue colour or soothing pattern when the wearer is relaxed or when a lower heart rate is detected. Conversely, during moments of excitement or elevated heart rate, the control circuit (130) may drive the display (110) to shift to a vibrant hue, a pulsing pattern, or a dynamic graphic. As an illustrative scenario, a user watching a live sports game while wearing the eyewear apparatus (100) may initially see the frames display their favourite team's colours and logo. As the match intensifies and biometric indicators reveal heightened adrenaline, the frames may gradually animate with a brighter version of the team colours or a more energetic pattern, thereby reflecting the thrill of the experience. This feature provides a fun, personalized visual indicator of the wearer's mood and engagement while maintaining ultra-low power operation due to the bistable nature of the display (110). The control circuit (130) may implement a mood-responsive mode in which the electronic paper display (110) of the eyewear apparatus (100) automatically changes appearance to mirror or augment the wearer's physiological or emotional state. Such adjustments may occur according to predefined logic embedded in the control circuit (130) or according to user-customized settings provided through the mobile computing device (202).

For example, the eyewear apparatus (100) may display a calm blue colour or soothing pattern when the biometric sensor (150) detects a relaxed state or lower heart rate. Conversely, during moments of excitement or elevated heart rate, the control circuit (130) may drive the display (110) to shift to a vibrant hue, a pulsing pattern, or a dynamic graphic. As an illustrative scenario, when a user is watching a live sports game, the frames may initially show the team's colours and logo; as the match grows intense and biometric indicators reveal heightened adrenaline, the frames may gradually animate with a brighter or more energetic version of the team's colours, thereby reflecting the user's mood and engagement.

To support this sensor-driven mode, the electronics design of this embodiment includes the additional biometric sensor hardware (150) and, in some cases, a more powerful or efficient control circuit (130) capable of handling real-time sensor processing. The fundamental frame construction remains unchanged, with the electronic paper display (110) integrated into the outward-facing surfaces of the frame (102), while the internal design and power management are tuned to accommodate the biometric sensors (150) and any wireless communication they may require (such as BLE transceiver (124)).

Since this advanced configuration uses comparatively more energy due to sensor sampling and potentially more frequent updates to the electronic paper display (110), the apparatus (100) is equipped with convenient recharging features. The power source (140), in one embodiment, is a larger-capacity rechargeable battery dimensioned to fit unobtrusively within the temple arms (106). To extend usability, the eyewear apparatus (100) may be paired with smart charging accessories. For instance, in one embodiment, a dedicated charging case (148) is provided, similar in function to those used for wireless earbuds. When the eyewear apparatus (100) is placed in the charging case (148), an internal secondary battery of the case transfers energy to the power source (140) of the eyewear via conductive contact pins or inductive wireless charging. This ensures that the eyewear apparatus (100) is automatically recharged whenever stored in the case (148), without requiring a direct cable connection.

In addition, the eyewear apparatus (100) may support compatibility with wireless charging pads, such as Qi-compatible inductive mats, so that the user may conveniently place the eyewear apparatus (100) on a charging surface at a desk or bedside. With these charging features and the integration of low-power management strategies in the control circuit (130), the eyewear apparatus (100) may achieve several days to a week of operation on a single charge, even under moderate biometric sensor use.

To further extend battery life, the advanced embodiment of the eyewear apparatus (100) employs aggressive power management strategies. All electronic modules are duty-cycled, meaning that they remain in a sleep or ultra-low-power state for the majority of the time and wake only in response to specific triggers. For example, the control circuit (130) may operate in a deep sleep mode, drawing only microamps of current, and may wake instantly when prompted by an event such as a user interaction with the frame (102), an incoming signal via the BLE transceiver (124), or a scheduled reading from a biometric sensor (150). Similarly, the NFC interface (122) remains inactive until an NFC field generated by a smartphone or tag is detected, with many NFC controller chips supporting hardware-level field detection to trigger wake-up.

The biometric sensors (150), when present, may be polled infrequently or sampled in bursts rather than continuously, thereby conserving energy, while the BLE transceiver (124) may operate in low-duty-cycle advertising or standby modes to minimize power usage when continuous communication is not required. In certain embodiments, the frame (102) incorporates transparent solar cells integrated along the top edge of the frame or on the temple arms (106). These photovoltaic strips, which may be designed to remain unobtrusive and nearly invisible to a casual observer, may trickle-charge the power source (140) whenever the eyewear apparatus (100) is exposed to sufficient ambient light.

In an optimal implementation, the combined use of solar charging and NFC-based power harvesting allows the eyewear apparatus (100) to minimize or even eliminate reliance on wired charging. This design may render the apparatus (100) substantially self-sustaining for everyday use, thereby enhancing user convenience while supporting extended battery life across both basic and advanced embodiments.

In another embodiment of the system (200), there may be automatic outfit coordination through passive identifiers embedded in articles of clothing or accessories. The eyewear apparatus (100) is provided with an NFC interface (122) configured to operate in a reader mode when required. In this mode, the control circuit (130) periodically or conditionally activates the NFC interface (122) to detect nearby tags.

Wardrobe items such as clothing, hats, or bags may include inexpensive, passive NFC tags embedded at the time of manufacture or added later by the user. Each tag may store data representative of the associated article, including, for example, a primary colour value, a pattern identifier, or a garment ID that corresponds to style information retrievable from a database. When the eyewear apparatus (100) is brought into proximity with such a tag—for example, when the user holds the frame (102) near a shirt or accessory, or when the glasses are worn during dressing—the NFC interface (122) detects the tag and the control circuit (130) wakes from a low-power state to read the stored data. This detection may occur in different ways:
Automatic polling, wherein the eyewear apparatus (100) intermittently scans for tags based on movement detected by an accelerometer or other motion sensor; or
Manual interaction, wherein the user deliberately brings the eyewear apparatus (100) into close contact with the tagged article.

Once the tag data has been retrieved, the control circuit (130) interprets the information to determine the desired appearance to be applied to the electronic paper display (110). Several scenarios may be implemented:
If the NFC tag stores a primary colour code (e.g., a red jacket encoding a hex value such as #FF0000), the control circuit (130) directly updates the electronic paper display (110) to present the same colour, so that the eyewear matches the garment.
If the NFC tag stores a pattern identifier (e.g., “floral pattern”), the eyewear may display either the same pattern on its frame or a complementary solid colour extracted from one element of the clothing pattern. For instance, when paired with a floral-print shirt, the frame might display a matching floral motif or a subtle green shade to complement the leaves in the print.
If the NFC tag stores a garment ID, the control circuit (130) may consult a lookup table stored locally or communicate via the BLE transceiver (124) with a mobile computing device (202) to fetch corresponding style information. For example, a formal black suit identified via its tag could prompt the eyewear to shift to a glossy black or silver pattern, while a brightly coloured party dress may result in the eyewear displaying a contrasting sparkle effect.
If multiple NFC-tagged garments are detected simultaneously (e.g., a tagged shirt and a tagged tie), the system may apply a priority rule or combination logic, choosing either a dominant garment's colour or a blended scheme. For example, if the shirt is blue and the tie is yellow, the eyewear may display either a matching blue, a yellow highlight pattern, or even a green tone as a blended outcome.

Through such tag-based outfit coordination, the eyewear apparatus (100) may instantly update its appearance to correspond to, complement, or contrast with the wearer's clothing, providing a seamless, hands-free experience without requiring manual input through the smartphone application.

There are several possible implementation approaches for the decision logic executed by the control circuit (130) once the NFC interface (122) reads data from a garment tag.

In one approach, the tag directly stores an exact colour or pattern code. For example, a tag embedded in a red jacket may contain the data “#FF0000,” corresponding to a pure red colour in hex code. In such a case, the eyewear apparatus (100) simply applies that precise colour to the electronic paper display (110), resulting in the frame (102) matching the garment exactly.

In another approach, the tag may store an abstract identifier such as “Pattern 7” or a unique garment ID. Upon detecting such a tag, the control circuit (130) may either consult a local lookup table stored within the eyewear apparatus (100) or communicate with an external source such as a mobile computing device (202) via the BLE transceiver (124) or with a cloud-based service to retrieve the style information associated with the identifier. For instance, a dress with a complex floral print may have a tag that, when read, prompts the smartphone app to send a specific floral pattern image to the eyewear apparatus (100). Alternatively, the system may select a complementary solid colour derived from one of the accent tones in the floral design.

This tag-based outfit coordination enables a fully hands-free experience, as the clothing itself provides the cue for updating the eyewear apparatus (100) without requiring the user to open the companion application. The system (200) may also implement multi-tag logic when multiple NFC-tagged garments are detected simultaneously. For example, if the user is wearing both a tagged shirt and a tagged hat, the eyewear apparatus (100) may combine the data to select an appearance that harmonizes with the overall outfit, such as prioritizing the shirt's colour as dominant while incorporating accent tones from the hat.

The garment tags may be implemented as washable sticker tags, sew-in fabric labels, or decorative patches such as an NFC-enabled logo badge on a jacket. Because these tags are passive and require no battery, they are inexpensive to produce, safe for laundering, and unobtrusive for everyday use, making them practical for large-scale adoption in clothing and accessories.

The appearance-coordination system (200) is complemented by a dedicated mobile application running on the user's smartphone (202), which significantly enhances usability and provides intelligent control of the eyewear apparatus (100). Through this application, the user may monitor system (200) status, including battery level, current frame appearance (colour, pattern, or graphic), and connectivity status. The application further enables extensive customization of the eyewear's behaviour through the following features:
Manual Control: A graphical interface such as a colour wheel, palette selection tool, or pattern gallery allows the user to manually design the frame's appearance. A text/emoji editor enables the user to add custom messages, icons, or symbols to the display. Where the eyewear apparatus (100) includes segmented e-ink panels (112), the user may individually address different segments—for example, colouring the temple arms (106) one colour, the bridge (104) another, or displaying a small icon on the temple surface.
Outfit Suggestion: An integrated outfit-matching engine allows the user to capture an image of their clothing via the smartphone (202) camera. The application analyses the dominant colours or patterns and suggests frame appearances that either match or complement the outfit. For instance, when the user is wearing a patterned shirt, the application may propose a solid frame colour selected from a tone within the pattern, or the reverse. Suggested styles may be previewed on a virtual model of the eyewear within the application before application to the physical frame.
Scheduling and Modes: The system (200) provides scheduling tools and automated modes. For example, the eyewear may be scheduled to automatically switch to a “work mode” appearance every weekday at 9:00 AM (e.g., conservative black or tortoise-shell patterns) and to a “casual mode” in the evening. Additional automated modes include a “mood ring” mode in which the frame appearance continuously adjusts according to biometric input from integrated sensors (150), and an “event mode” where the eyewear reacts dynamically to music, lighting, or external event signals (when such infrastructure is available). These modes are user-configurable and toggled directly within the app.
Firmware Updates and Configuration: The application also supports over-the-air firmware updates to the eyewear apparatus (100), either through BLE (124) or in chunks via NFC (122). It allows configuration of system settings such as sensitivity thresholds for mood detection, priority rules for multi-garment outfit matching, and authorization lists for friends or devices permitted to participate in group synchronization.

In another embodiment, the system (200) includes a Bluetooth Low Energy (BLE) transceiver (124) in addition to or instead of the NFC interface (122). The BLE functionality substantially extends the communication range (up to approximately 10 meters) and capability of the eyewear apparatus (100), enabling both continuous and event-driven connections with the smartphone (202) and direct communication with other nearby BLE-enabled eyewear devices (100). This expanded connectivity allows for the following features:
Remote App Control: The user may alter the frame's appearance in real time via the application without needing to physically tap the smartphone (202) against the frame. For example, the user may swipe through a series of colours or patterns on the application, and the eyewear apparatus (100) updates instantaneously via BLE communication. The application may also poll the eyewear device for battery status, sensor readings, or connectivity state, and display these parameters to the user.
Location/Context Triggers: By leveraging GPS, Wi-Fi, and internet connectivity of the smartphone (202), the system (200) may update the eyewear's appearance automatically based on contextual triggers. For example, a user may define geofenced themes such as “work,” “gym,” “home,” or “party. ” When the smartphone detects that the user has entered the workplace, the eyewear apparatus (100) may automatically switch to a conservative professional appearance. Conversely, upon arrival at the gym, the eyewear may adopt high-visibility sport colours.
Group Synchronization: The BLE capability allows group interaction. Multiple eyewear devices (100) may form a group session via the system (200). In one approach, a designated “leader” user may select a colour or pattern which is broadcast to all other group participants' eyewear devices (100), thereby synchronizing frame appearances across the group. In another approach, an event organizer may transmit a BLE broadcast to all participating devices—for example, at a concert, theme park, or sports stadium—causing thousands of glasses to simultaneously display team colours, concert effects, or synchronized animations. In peer-to-peer scenarios, two users wearing eyewear apparatuses (100) may have their frames briefly blink or shift colours when they come into close proximity, serving as a social greeting or recognition cue.
Data Exchange: The BLE channel further enables transfer of sensor data (e.g., biometric readings) from the eyewear apparatus (100) to the smartphone (202) for storage, health monitoring, or advanced analytics. BLE may also allow integration with external systems, potentially supporting gesture or voice-control features if additional sensors are incorporated in future designs.

All BLE-enabled functions are implemented with power efficiency in mind. The BLE transceiver (124) operates in low-duty-cycle modes, advertising infrequently and using short connection intervals so that the impact on battery life remains minimal unless high-activity communication is in progress.

The system (200) ensures intuitive and enjoyable operation of the eyewear apparatus (100). At a basic level, the user may select any colour or pattern with a few taps on the smartphone (202), transforming the eyewear instantly. The frames may be matched to a mood (e.g., bright hues for cheerfulness, neutral tones for subtlety) or to an outfit (via NFC garment tags or through outfit-analysis in the app). The eyewear may also display small text, emojis, or icons on the temples (106) for personalization. In practice, the eyewear functions as a fashion canvas capable of restyling itself on demand, while retaining the natural look and comfort of conventional eyewear.

The eyewear apparatus (100) is designed to be lightweight, durable, and weather-resistant. All electronic components are sealed within the frame (102) for water resistance, allowing the device to be worn in rain or while washing the face. Because the electronic paper display (110) is reflective and bistable, the eyewear remains clearly visible in sunlight without glare. The frame's outward appearance, when idle, is simply the last set colour or pattern, with no blinking lights or visible screens, preserving a natural aesthetic. When powered off, the frame (102) simply retains its last set appearance and there are no blinking lights or obvious screens, preserving the natural aesthetic of traditional eyewear.

Additionally, owning a single adaptable eyewear apparatus (100) reduces waste and cost over time. Instead of purchasing multiple fashion-specific frames, the user invests in one smart frame that digitally “owns” countless styles. This is both economically beneficial and environmentally friendly, reducing plastic consumption and the disposal of outdated eyewear.

In a nutshell, the detailed embodiments above describe how the present disclosure may be realized in practice:
Base variant: A configuration including only the NFC interface (122), the electronic paper display (110), and minimal electronics achieves the primary goal of colour-changeable frames with virtually zero idle power consumption. Updates are performed manually via a smartphone (202) tap, maximizing battery life (potentially lasting many months on a charge or even operating battery-free using harvested NFC energy).
Advanced variant: A configuration that adds components such as the BLE transceiver (124) and biometric sensors (150), enabling automatic and interactive functions including outfit auto-detect, mood sensing, group synchronization, and location-based changes. Although this variant consumes more power, it is supported by efficient power management and convenient charging solutions such as inductive charging, a charging case (148), or solar augmentation, making it practical for everyday use.
Both embodiments share the inventive concept of integrating bistable displays into eyewear (100) to merge fashion with adaptive technology, while overcoming the power and usability challenges that typically limit wearable display devices.

### Example Use Cases

Outfit Auto-Match: The user wears a shirt with an embedded NFC tag. As the eyewear apparatus (100) is worn, the NFC interface (122) detects the tag and the control circuit (130) updates the display (110) to complement the shirt. The user immediately sees coordinated styling in the mirror, without manual input to the mobile device (202).
Mood Ring Glasses: The user activates mood mode. While calm at work, the eyewear (100) shows a steady soft colour. Later, during a stressful meeting, biometric sensors (150) detect elevated heart rate and prompt the control circuit (130) to update the display (110) with a pulsing pattern. As the user relaxes afterward, the glasses return to a calming appearance.
Group Sync at an Event: At a music festival, multiple users wear eyewear apparatuses (100). Through the mobile computing device (202) and BLE transceivers (124), they join a shared session so all frames update in unison. For instance, one user selects a rainbow strobe pattern, instantly synchronizing all displays (110) across the group.
Location-Based Style: The system (200) is configured with location triggers. When the mobile device (202) detects the user arriving at the office, the eyewear (100) switches to a conservative navy-blue design. Later, as the user heads to a social outing, the glasses automatically change to a vibrant evening style—no manual input required.
Instant Colour Sampling (“Eyewear Eyedropper”)—The apparatus (100) includes a small colour sensor or camera on the frame that can scan the colour of any object or fabric the user points at, instantly updating the frame's appearance to that sampled colour or pattern. For example, a user may tap their glasses against a handbag or shirt, and the frame may mimic that exact shade or design, making outfit coordination effortless on the fly. This is an intuitive, playful way to match attire without needing pre-programmed NFC tags or manual selection in the app. This innovative “point-and-pick” colour feature is a fresh interaction mechanism—essentially turning the glasses into a colour picker tool for the real world.

These examples demonstrate the versatility of the invention, showcasing how the eyewear apparatus (100) and system (200) flexibly adapt to real-world contexts.

As further illustrated in FIGS. 1C and 1D, the integrated appearance-coordination system (200) combines the eyewear apparatus (100), a mobile computing device (202), and an external source of contextual attributes (204).

The eyewear apparatus (100) includes the spectacle frame (102) with a bridge (104), temple arms (106), and lenses (108). At least one multi-colour bistable electronic paper display (110) is disposed on the outward-facing surface of the frame (102). The display (110) may be implemented as segmented display regions (112) on different frame portions, as shown in FIG. 1C, thereby allowing different parts of the frame to exhibit independent colours, patterns, or graphics.

In one embodiment, as illustrated in FIG. 1C, the electronic paper display (110) of the eyewear apparatus (100) is divided into a plurality of segmented display regions (112) disposed on different portions of the frame (102), such as the bridge (104), temple arms (106), and rims around the lenses (108). Each segmented display region (112) may be independently driven by the control circuit (130), allowing different frame portions to exhibit distinct colours, patterns, or graphics. For example, the temple arms (106) may display a solid tone while the bridge (104) shows a complementary graphic or symbol, or each segment may adopt contrasting designs for creative personalization. This configuration enables multi-colour styling, partial-frame designs, or the display of icons, text, or branding, thereby expanding the expressive capabilities of the eyewear apparatus (100).

In FIG. 1D, the eyewear apparatus (100) is illustrated with biometric sensors (150) embedded at the inner contact points of the frame (102), enabling physiological monitoring such as heart rate, temperature, or galvanic skin response. The biometric sensors (150) may include, for example, a heart-rate sensor, a skin-temperature sensor, or a galvanic skin response sensor. These sensors provide physiological data to the control circuit (130), which dynamically updates the electronic paper display (110) in response to the wearer's physiological or emotional state. For instance, the frame (102) may shift to a calm blue tone when stress is detected, or transition to vibrant animated patterns when excitement levels increase. This “mood-responsive” functionality provides an intuitive visual reflection of the user's state and enhances personalization of the eyewear apparatus (100). These sensors (150) feed data into the control circuit (130), which is coupled to the wireless communication module (120) that includes both the NFC interface (122) and BLE transceiver (124). The power source (140), such as a rechargeable battery, is integrated into one of the temple arms (106), optionally rechargeable via an inductive coil or charging case (148).

The charging case (148) includes a secondary battery that recharges the eyewear apparatus (100) via conductive contacts or inductive wireless transfer whenever the glasses are stored inside. This arrangement allows automatic recharging without the need for a direct wired connection to the frame (102). In addition, in other embodiments, transparent photovoltaic cells are embedded along the top edges of the temple arms (106) or the bridge (104), providing supplemental trickle charging under ambient light conditions. The combination of inductive charging, solar harvesting, and NFC power harvesting enables the eyewear apparatus (100) to maintain extended operational life with minimal user intervention, and in some cases may eliminate the need for wired charging altogether.

In a further embodiment, articles of clothing or accessories worn by the user may be embedded with passive NFC tags encoding appearance data such as a colour code, pattern identifier, or garment ID. The eyewear apparatus (100), configured with an NFC interface (122) operating in reader mode, detects and retrieves this data when brought into proximity with the tagged article. The control circuit (130) then interprets the retrieved data and updates the electronic paper display (110) accordingly. For example, a red jacket with a tag encoding “#FF0000” may cause the eyewear apparatus (100) to adopt the same red colour, while a patterned shirt may prompt the eyewear apparatus (100) to either display a corresponding floral motif or a complementary solid colour. This automatic coordination enables seamless, hands-free synchronization of the eyewear with the user's outfit, without requiring any manual input through the mobile application.

The mobile computing device (202) is depicted in FIG. 2A, and may be a smartphone, smartwatch, or tablet. The device (202) comprises a processor, memory, a camera (202A), an NFC reader (202B), and a wireless transceiver (202C) such as BLE or Wi-Fi. The mobile computing device (202) is programmed to detect contextual attributes through multiple modalities:
(i) by reading data from NFC tags embedded in clothing or accessories,
(ii) by capturing an image of the user or environment using the camera (202A) and analyzing it to identify colour or pattern data, or
(iii) by receiving contextual data (204) such as mood indicators, event themes, or environmental conditions from external databases, servers, or IoT networks.

Once the contextual attribute is determined, the mobile computing device (202) generates a recommended appearance for the eyewear apparatus (100). This recommended appearance may comprise a colour, pattern, graphic, texture, symbol, image, or a combination thereof. The mobile device (202) then transmits a wireless command via its transceiver (202C) to the communication module (120) of the eyewear apparatus (100). The control circuit (130) responds by driving the e-paper display (110) to exhibit the determined appearance.

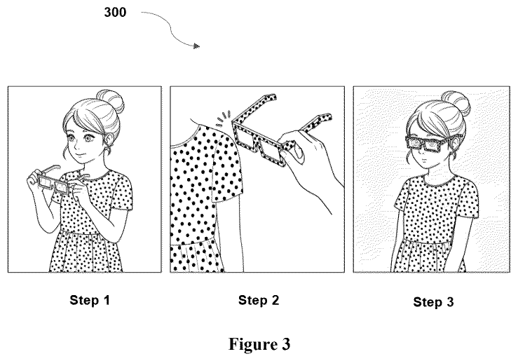

FIG. 3 illustrates the integrated method (300) of operation of the system (200). The method involves a number of steps, sequence thereof may be exemplary.
Step 1—Detecting contextual data: As depicted in FIG. 3, the method (300) begins by detecting contextual data associated with the user. The contextual attribute may include attire, mood, environmental conditions, or an event theme. Detection may occur in several ways. In one embodiment, the mobile computing device (202) reads an NFC tag associated with an article of clothing or accessory, the tag storing a colour code, a pattern identifier, or an item ID linked to appearance data. In another embodiment, the mobile computing device (202) captures an image of the user or surroundings through its camera and analyzes the image to identify colours, textures, or patterns. In further cases, contextual data (204) may be received from external sources such as a cloud server, an event organizer, or an IoT-based sensor, providing details of mood, lighting, or event themes. In embodiments where the eyewear apparatus (100) includes biometric sensors (150), physiological data such as heart rate, skin temperature, or galvanic response may also be collected and treated as mood-related input.
Step 2—Determining the recommended appearance: Once contextual data is detected, the mobile computing device (202) processes it to determine a recommended appearance for the eyewear apparatus (100). The appearance may include one or more of a colour, pattern, graphic, texture, image, symbol, or combination thereof. The selected appearance may correspond to, complement, or contrast with the contextual attribute. For instance, if the attire is a blue shirt identified via an NFC tag, the eyewear apparatus (100) may display a coordinating shade of blue; if biometric data indicates stress, a calming gradient in cool tones may be applied.
Step 3—Updating the eyewear apparatus (100): After determining the recommended appearance, the mobile computing device (202) transmits a wireless command via the NFC interface (122), BLE transceiver (124), or another communication channel to the eyewear's communication module (120). The control circuit (130), upon receiving the command, interprets the data and drives the bistable electronic paper display (110) to update its state. Because the display (110) is bistable, the updated colour, pattern, or graphic remains visible without continuous power, preserving the low-energy profile of the eyewear apparatus (100).
Step 4—Synchronization and advanced modes: In some embodiments, the method (300) also enables group coordination. Multiple eyewear apparatuses (100) may synchronize their displays (110) either through commands from the mobile computing device (202) or by exchanging data directly via BLE transceivers (124). This allows multiple users to share a coordinated appearance, for example, in social events or team settings. The method may also include location-based triggers, whereby the mobile computing device (202) updates the eyewear appearance when the user enters specific locations, such as switching to a professional design at the office or a vibrant pattern at the gym. Likewise, multiple contextual attributes may be combined, with the system (200) applying blending logic or priority rules to generate the final display appearance.

The method (300) provides a seamless, adaptive, and energy-efficient process for dynamically updating the eyewear's appearance in response to user context, while ensuring natural aesthetics and everyday usability.

In yet another embodiment, the eyewear apparatus (100) operates as part of an integrated system (200), as shown in FIGS. 1C, 1D, 2A-2C, and 3. The system (200) comprises the eyewear apparatus (100), a mobile computing device (202) such as a smartphone, smartwatch, or tablet, and optionally one or more external contextual sources (204) such as servers, event organizers, or IoT devices. The mobile computing device (202) detects contextual attributes—such as attire, mood, environment, or location—by reading NFC garment tags (202B), analyzing images captured by its camera (202A), or receiving external data (204). Based on this contextual input, the mobile computing device (202) determines a recommended appearance and transmits it to the eyewear apparatus (100) via NFC (122) or BLE (124). The control circuit (130) then drives the electronic paper display (110) to exhibit the selected appearance. In some embodiments, multiple eyewear apparatuses (100) can be synchronized via BLE, enabling coordinated group displays in events or social gatherings.

### Advantages of the Present Disclosure

The present disclosure offers several technical and practical advantages over conventional eyewear and fashion accessories:
Dynamic Personalization: A single eyewear frame (102) may present thousands of colour variations, patterns, graphics, or symbols via integrated electronic paper displays (110), allowing users to customize appearance on demand without owning multiple physical frames.
Ultra-Low Power Operation: The bistable electronic paper displays (110) consume power only during updating the appearance and retains the selected appearance indefinitely without continuous energy input, ensuring long battery life and reduced charging requirements.
Seamless Wireless Control: Integrated NFC (122) and optional BLE (124) interfaces allow convenient updates from a smartphone (202), NFC tag, or cloud service, supporting both manual customization and automated appearance coordination.
Context-Responsive Functionality: The eyewear may adapt its appearance automatically based on contextual attributes such as user attire, environmental conditions, calendar events, or themes, enhancing style coordination and user convenience.
Mood-Based Adaptation: With integrated biometric sensors (150), the eyewear apparatus (100) may detect physiological indicators like heart rate or skin temperature and adjust its appearance dynamically to reflect or influence the wearer's mood.
Group Synchronization: BLE connectivity enables multiple eyewear devices (100) to synchronize and exhibit common patterns or coordinated effects, enhancing social experiences at events, celebrations, or sports gatherings.
Durability and Aesthetics: The electronic components are discreetly embedded and sealed within the frame (102), ensuring water resistance, lightweight comfort, and a natural, non-emissive appearance indistinguishable from traditional eyewear when not actively changing.
Convenient Power Management: Options such as inductive charging (148), wireless charging pads, and even transparent solar cells provide flexible recharging, while aggressive power management ensures sustained performance.
Environmental and Economic Benefits: By reducing the need for multiple frames for fashion purposes, the invention minimizes material waste and cost, promoting sustainability while expanding user style options.
Scalable Embodiments: The disclosure supports both a minimal, NFC-receiver embodiment (basic low-power colour updates) and advanced smart embodiments with NFC transceiver for both transmitting and receiving data (with sensors, BLE, solar charging, and outfit-synchronization), making the technology adaptable for various commercial product lines.

The foregoing descriptions of exemplary embodiments of the present disclosure have been presented for purposes of illustration and description. They are not intended to be exhaustive or to limit the disclosure to the precise forms disclosed, and obviously many modifications and variations are possible in the light of the above teachings. The exemplary embodiments were chosen and described in order to best explain the principles of the disclosure and its practical application, to thereby enable others skilled in the art to best utilize the disclosure and various embodiments with various modifications as are suited to the particular use contemplated.

We claim

1. An appearance-changing eyewear apparatus (100), comprising:
a spectacle frame (102) comprising a bridge (104) and temple arms (106) for supporting lenses (108);
at least one multi-colour bistable electronic paper display (110) disposed on an outward-facing surface of the frame (102), the display (110) selectively changing the appearance of the frame (102), the appearance selected from one or more of a colour, a pattern, a graphic, a texture, an image, a symbol and/or a combination thereof, in response to an activation means, and retaining the selected appearance without continuous power;
a wireless communication module (120) in the frame (102), the module (120) having a near-field communication (NFC) interface (122) for receiving data from an external device or tag;
a control circuit (130) in the frame (102) and operatively coupled to the electronic paper display (110) and the communication module (120), the control circuit (130) receiving data representing a selected appearance of the selected frame and to drive the electronic paper display (110) to exhibit the selected appearance in response via the communication module (120), thereby dynamically modifying appearance of the eyewear apparatus (100).

2. The apparatus (100) of claim 1, wherein the display (110) has a thickness suitable for integration within the frame (102) and is conformally mounted within the curved surface of the frame (102).

3. The apparatus (100) of claim 1, wherein the display (110) is disposed beneath a transparent protective layer (114), such that the display (110) is seamlessly embedded into the frame (102) without altering form factor or the natural appearance of the frame thereof.

4. The apparatus (100) of claim 1, wherein the electronic paper display (110) comprises multiple segmented display regions (112) on different parts of the frame (102), each of the multiple segmented display regions (112) being individually addressable by the control circuit (130) to display varied changes in the appearance of the frame (102).

5. The apparatus (100) of claim 1, wherein the NFC interface (122) obtains power from an external NFC emitter's field during data transfer from phone, such that the eyewear apparatus (100) updates the display (110) using energy obtained wirelessly without relying on any inbuilt battery or power source (140).

6. The apparatus (100) of claim 1, wherein the frame (102) and all integrated electronic components are sealed for water resistance, thereby protecting the eyewear apparatus (100) against sweat, moisture or rain ingress.

7. The apparatus (100) of claim 1, wherein the electronic paper display (110) is a reflective, non-emissive display that operates without backlighting and without continuous electrical power to maintain a selected appearance, such that the frame (100) presents a natural, non-illuminated look corresponding to the selected appearance.

8. The apparatus (100) of claim 1, wherein the electronic paper display (110) is disposed on one or more frame sections selected from the group consisting of the temple arms (106), the bridge (104), and rim portions adjacent the lenses (108).

9. The apparatus (100) of claim 1, wherein the wireless communication module (120) comprises a Bluetooth Low Energy (BLE) transceiver (124) in addition to the NFC interface (122).

10. The apparatus (100) of claim 1, comprising at least one biometric sensor (150) integrated into the frame (102) and operatively connected to the control circuit (130), the biometric sensor (150) being selected from the group consisting of a heart-rate sensor, a temperature sensor, or a galvanic skin response sensor.

11. The apparatus (100) of claim 1, further comprising the BLE wireless transceiver (124) integrated into the frame (102) and operatively connected to the control circuit (130), wherein the BLE transceiver (124) enables communication between the control circuit (130) and external devices over a short-range wireless link for exchange of data and control commands in an active energy use mode.

12. The apparatus (100) of claim 1, wherein the optional power source (140) comprises a rechargeable battery, and the apparatus (100) further comprises an inductive charging coil or wireless power receiver integrated into the frame and electrically connected to the rechargeable battery, the inductive receiver wirelessly receiving charging power from an external charging transmitter so as to recharge the battery without a wired connection.

13. The apparatus (100) of claim 1, further comprising a dedicated charging case (148) for housing the apparatus (100), the charging case (148) comprising a secondary battery and a charging interface, wherein when the apparatus (100) is placed in the case (148), the charging interface transfers energy from the secondary battery to recharge the power source (140), the charging interface comprising inductive coupling or electrical contacts such that the apparatus (100) begins charging automatically upon being stowed in the case (148).

14. The apparatus (100) of claim 1, wherein the activation means comprises at least one of an electrical signal, an electromagnetic field, an optical input, or a thermal input.

15. The apparatus (100) of claim 1, wherein the BLE transceiver (124) is configured to communicate with one or more other eyewear apparatuses (100) to synchronize or coordinate the appearance of the eyewear apparatus (100) with those of the other eyewear apparatuses.

16. The apparatus (100) of claim 1, wherein the NFC interface (122) in active transceiver mode detects and determines the NFC tags in an attire, garment or outfit and determines the recommended appearance of the apparatus (100) based on one or more of a color, a pattern, a graphic, a texture, an image, a symbol or a combination thereof identified in the attire.

17. The apparatus (100) of claim 1, further including a wireless interface to communicate with a remote server (cloud) (206), wherein the control circuit (130) is to receive appearance update data processed using AI and recommendations based on contextual triggers such as the day's weather, time of the day, location of the user, among others from the remote server (206) and to apply the received appearance update to the electronic paper display (110).

18. The apparatus (100) of claim 1, wherein the apparatus acts as an instant colour sampling device by including a small colour sensor or camera on the frame that scans the colour of any object or fabric the user points at, instantly updating the frame's appearance to that sampled colour or pattern and mimics exact shade or design of the object when the apparatus being tapped on the object.

19. The apparatus (100) of claim 1, further comprising an on-board environmental colour-sampling sensor or micro-camera (160) to capture a colour or pattern from an external object, and wherein the control circuit (130) uses the captured colour or pattern to update the electronic paper display (110) to match or to derive a complementary appearance.

20. The apparatus (100) of claim 10, wherein the control circuit (130) is configured to analyse data from the biometric sensor (150) and adjust the appearance of the electronic paper display (110) in response to a physiological state of the wearer, thereby implementing a mood-based feature in which the appearance dynamically reflects or responds to biometric indicators of the wearer.

21. A system (200) for coordinating appearance of an eyewear apparatus (100) with one or more contextual attributes, the system (200) comprising:
a spectacle frame (102) comprising a bridge (104) and temple arms (106) for supporting lenses (108);
at least one multi-colour bistable electronic paper display (110) disposed on an outward-facing surface of the frame (102), the display (110) selectively changing the appearance of the frame (102), the appearance comprising either a colour or a pattern or a combination thereof, in response to an activation means, and retaining the selected appearance without continuous power;
a wireless communication module (120) in the frame (102) having a near-field communication (NFC) interface (122) for receiving data from an external device or tag;
a control circuit (130) in the frame (102) operatively coupled to the electronic paper display (110) and the communication module (120), the control circuit (130) receiving data representing a selected appearance of the frame (102) and driving the electronic paper display (110) to exhibit the selected appearance; and
a mobile computing device (202) having a processor, a camera, and a wireless transmitter for communicating with the communication module (120),
wherein the mobile computing device (202) acquires contextual data, analyses the contextual data to determine a recommended appearance for the spectacle frame (102), and transmits a command wirelessly to the wireless communication module (120), thereby updating the electronic paper display (110) to the recommended appearance automatically.

22. The system (200) of claim 21, wherein the contextual data comprises at least one of user attire, user mood, an environmental condition, or an event theme.

23. The system (200) of claim 21, wherein the contextual data comprises user attire, and the mobile computing device (202) captures an image of the attire and determines the recommended appearance based on one or more a colour, a pattern, a graphic, a texture, an image, a symbol or a combination thereof identified in the attire.

24. The system (200) of claim 21, wherein the contextual data comprises user mood, and the system (200) comprises at least one biometric sensor (150) in the frame (102) operatively coupled to the control circuit (130), the biometric sensor (150) providing physiological data used to determine the recommended appearance.

25. The system (200) of claim 21, wherein the contextual data comprises an environmental condition detected by the mobile computing device (202), the environmental condition including at least one of ambient lighting, temperature, or geographic location.

26. The system (200) of claim 21, wherein the contextual data comprises an event theme received by the mobile computing device (202) from an external source including receiving contextual data or recommended appearance data from a remote server or cloud-based service.

27. The system (200) of claim 21, wherein the mobile computing device (202) comprises a user interface that allows manual customization of appearance of the eyewear apparatus (100), the user interface allowing selection of a specific color, pattern, or graphic for the frame (102), overriding or supplementing the automatically determined appearance.

28. The system (200) of claim 21, wherein the mobile computing device (202) applies a predefined style rule to contextual data, determines a complementary or contrasting appearance for the eyewear apparatus (100), the appearance comprising a colour, a pattern, a graphic, a texture, an image, or a symbol or any combination thereof for the eyewear frame (102), and presents the determined appearance to the user for approval prior to transmitting an update command to the eyewear apparatus (100).

29. The system (200) of claim 21, wherein the mobile computing device (202) communicates with a plurality of eyewear apparatuses (100) and synchronizes their appearances to exhibit a common or coordinated appearance.

30. The system (200) of claim 21, wherein the mobile computing device (202) determines the recommended appearance based on a scheduled time, calendar event, or detected location of the user.

31. The system (200) of claim 21, wherein the mobile computing device (202) combines two or more contextual attributes selected from user attire, user mood, environmental condition, or event theme to determine the recommended appearance.

32. The system (200) of claim 21, wherein the mobile computing device (202) transmits the corresponding update or appearance change commands to the eyewear apparatus (100) either via a tap of the mobile device (202) on the eyewear apparatus (100) directly in the low power NFC data and NFC power transmission mode or through BLE in active power advanced connectivity mode.

33. The system (200) of claim 21, wherein the eyewear apparatuses (100) are configured to communicate directly with each other via the BLE transceiver (124) to synchronize their appearances without relying on the mobile computing device (202).

34. The system (200) of claim 21, wherein the contextual attribute comprises a physiological state of the user, and the mobile computing device (202) or the control circuit (130) of the eyewear apparatus (100) determines the appearance of the eyewear apparatus (100) based on data from at least one biometric sensor (150) integrated into the eyewear apparatus (100).

35. The system (200) of claim 21, wherein the remote server (206) stores anonymized aggregated analytics obtained from a plurality of users and provides crowd-based appearance recommendations or event-driven appearance presets to the mobile computing device (202) for distribution to eyewear apparatuses (100).

36. The system (200) of claim 21, wherein the mobile computing device (202) or the remote server (206) that implements an AI based personalization engine that learns user preferences and stores historical appearance and biometric data in an analytics module and generates AI based analytics dashboard presenting trends, summaries, or suggestions based on past appearance changes, biometric measurements, or contextual events, where the personalized AI assistant learns from historical usage and automatically recommends or auto-selects appearances for the eyewear apparatus (100) based on learned preferences, calendar entries, weather, or the user's past acceptance/rejection actions.

37. The system (200) of claim 21, wherein the mobile computing device (202) and the eyewear apparatus (100) are networked with a remote server (206) that hosts user profiles, wardrobe metadata, scheduled triggers, or event information, and wherein the mobile computing device (202) receives contextual triggers or recommended appearances from the remote server (206) and relays corresponding update commands to the eyewear apparatus (100).

38. A method (300) of updating an eyewear apparatus (100) having at least one multi-colour bistable electronic display (110), the method (300) comprising:
detecting data from an NFC tag associated with a contextual attribute of a user such as mood thereof or the clothes they are wearing;
determining an appearance for the electronic paper display (110) based on the detected data, the appearance comprising a colour, a pattern, a graphic, a texture, a symbol, or any combination thereof, such that the determined appearance corresponds to, complements, or contrasts with the contextual attribute; and
activating the electronic paper display (110) of the eyewear frame (102) to exhibit the determined appearance either in passive mode using power transmitted through external mobile device or an internal inbuilt power source, thereby changing the appearance of the eyewear apparatus (100) in coordination with the contextual attribute.

39. The method (300) of claim 38, wherein the contextual attribute comprises user attire, and detecting the data comprises reading an NFC tag directly from the eyewear apparatus (100) without the need of a second device such as a mobile phone, where the data detected by the NFC tag being associated with the article of clothing worn by the user, and the NFC tag storing appearance data such that the determined appearance corresponds to, complements, or contrasts with the article of clothing.

40. The method (300) of claim 38, wherein the contextual attribute comprises user attire, and detecting the data comprises reading an identifier from an NFC tag associated with an article of clothing worn by the user and retrieving corresponding appearance data from a database accessible to the NFC reader (122) or the control circuit (130), such that the determined appearance corresponds to, complements, or contrasts with the article of clothing.

41. The method (300) of claim 38, wherein detecting the data is performed by a mobile computing device (202) having an NFC reader, the method (300) further comprising transmitting the determined appearance from the mobile computing device (202) to the eyewear apparatus (100) via a wireless link, such that the control circuit (130) of the eyewear apparatus (100) activates the electronic paper display (110) to exhibit the determined appearance that corresponds to, complements, or contrasts with the contextual attribute.

42. The method (300) of claim 38, wherein detecting the data is performed by the NFC reader (122) integrated into the eyewear apparatus (100), and the control circuit (130) of the eyewear apparatus (100) determines and activates the appearance internally, such that the determined appearance corresponds to, complements, or contrasts with the contextual attribute without requiring the mobile computing device (202).

43. The method (300) of claim 38, wherein determining the appearance comprises combining two or more contextual attributes selected from user attire, user mood, an environmental condition, and an event theme, and generating an appearance that corresponds to, complements, or contrasts with the combination.

44. The method (300) of claim 38, wherein determining the appearance comprises applying a predefined style rule to the contextual attribute to generate an appearance that corresponds to, complements, or contrasts with the contextual attribute.

45. The method (300) of claim 38, further comprising synchronizing the appearance of the eyewear apparatus (100) with one or more other eyewear apparatuses (100) by directly exchanging data between the eyewear apparatuses (100) via BLE communication, such that the eyewear apparatuses (100) exhibit a common or coordinated appearance without relying on the mobile computing device (202).

46. The method (300) of claim 38, wherein detecting the data comprises obtaining biometric data from at least one biometric sensor (150) integrated into the eyewear apparatus (100), and wherein determining the appearance comprises adjusting the electronic paper display (110) to correspond to, complement, or contrast with a physiological state of the user.

47. The method (300) of claim 38, wherein the method (300) comprising capturing a colour or pattern from an external object using an on-board colour-sampling sensor or micro-camera (160) on the eyewear apparatus (100); extracting a colour value or pattern identifier from the captured image; and applying the extracted colour value or pattern identifier to the electronic paper display (110) as the determined appearance.

48. An integrated appearance-coordination system, comprising:
an eyewear apparatus (100) including a spectacle frame (102) with at least one multi-colour bistable electronic paper display (110) integrated into the frame (102), a wireless communication interface (120), and a control circuit (130) configured to drive the electronic paper display (110) in response to received commands;
a mobile computing device (202) configured to communicate with the eyewear apparatus (100), the mobile computing device (202) comprising a processor, a camera, an NFC reader, and a wireless transceiver; and
an external source associated with a contextual attribute of a user;
wherein the mobile computing device (202) is programmed to detect the contextual attribute by at least one of:
(i) reading data from an NFC tag associated with an article of clothing or accessory,
(ii) capturing an image of the user or environment using the camera and analyzing the image, or
(iii) receiving contextual data indicative of a mood, environmental condition, or event theme; and
wherein the mobile computing device (202) determines an appearance for the eyewear apparatus (100) based on the contextual attribute, the appearance comprising a colour, a pattern, a graphic, a texture, a symbol, or any combination thereof, such that the determined appearance corresponds to, complements, or contrasts with the contextual attribute, and transmits a wireless command to the eyewear apparatus (100), causing the control circuit (130) to update the electronic paper display (110) to exhibit the determined appearance.

49. The integrated appearance-coordination system of claim 48, wherein the electronic paper display (110) is bistable such that it retains a most recently set appearance in the absence of power, and wherein the eyewear apparatus (100) remains in a low-power standby state until receiving the wireless command or NFC trigger to change the display.

50. The integrated appearance-coordination system of claim 48, wherein the mobile computing device (202) is further configured to detect and recognize multiple contextual attributes, including a plurality of NFC-tagged clothing articles, and to determine the appearance of the eyewear apparatus (100) based on a combination of the contextual attributes or based on a priority rule among them.

51. The integrated appearance-coordination system of claim 48, wherein the mobile computing device (202) is further programmed with a user interface that allows manual customization of the appearance of the eyewear apparatus (100), including selection of a colour, a pattern, a graphic, a texture, a symbol, or any combination thereof, overriding or supplementing the automatically determined appearance.

52. The integrated appearance-coordination system of claim 48, wherein determining the appearance comprises applying a predefined style rule to the contextual attribute to generate an appearance that corresponds to, complements, or contrasts with the contextual attribute.

53. The integrated appearance-coordination system of claim 48, wherein the mobile computing device (202) communicates with a plurality of eyewear apparatuses (100) and synchronizes their appearances to exhibit a common or coordinated appearance.

54. The integrated appearance-coordination system of claim 48, wherein the mobile computing device (202) is further configured to determine the appearance of the eyewear apparatus (100) based on at least one of a scheduled time, a calendar event, or a detected location of the user.

55. The integrated appearance-coordination system of claim 48, wherein the mobile computing device (202) receives contextual data or recommended appearance data from a remote server or cloud-based service and transmits the corresponding update command to the eyewear apparatus (100).

56. The integrated appearance-coordination system of claim 48, wherein the eyewear apparatuses (100) communicate directly with each other via the BLE transceiver (124) to synchronize their appearances without relying on the mobile computing device (202).

57. The integrated appearance-coordination system of claim 48, wherein the contextual attribute comprises a physiological state of the user, and the control circuit (130) of the eyewear apparatus (100) analyzes data from at least one biometric sensor (150) and updates the electronic paper display (110) to exhibit an appearance that corresponds to, complements, or contrasts with the physiological state or user's mood.

58. The integrated appearance-coordination system of claim 48, wherein the external source (204) comprises one or more IoT devices or event servers to transmit contextual triggers to the mobile computing device (202) or remote server (206), and wherein the mobile computing device (202) determines a recommended appearance based on at least one of: an IoT-provided lighting condition, a venue event theme, or a broadcast event identifier.
